(19) United States
(12) Patent Application Publication
(10) Pub. No.: US 2006/0001861 A1
(43) Pub. Date: Jan. 5, 2006

(54) Measuring method and measuring system for measuring the imaging quality of an optical imaging system

(75) Inventor: Ulrich Wegmann, Koenigsbronn (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/155,561

(22) Filed: Jun. 20, 2005

Related U.S. Application Data
(63) Continuation of application No. PCT/EP02/14559, filed on Dec. 19, 2002.

(51) Int. Cl. G01B 9/00

(52) U.S. Cl. 356/124

(57) ABSTRACT

In a measuring method for measuring the imaging quality of an optical imaging system (10), a measuring mask is provided, which has a mask structure (20), which can be arranged in the region of an object surface of the imaging system. Furthermore, provision is made of a reference structure (23) adapted to the mask structure, which reference structure is to be arranged in the image surface (12) of the imaging system, and a two-dimensionally extended, radiation-sensitive recording medium (24), which is arranged in a recording position in such a way that a superimposition pattern that arises when the mask structure is imaged onto the reference structure can be detected by the recording medium. For the evaluation of the recording medium, the recording medium is brought from the recording position into an evaluation position remote therefrom. The measuring method and the associated measuring system are particularly suitable for fast, high-precision measurement of projection objectives in the incorporated state in microlithography projection exposure apparatuses.

This application is a continuation application of international patent application PCT/EP02/14559, filed on Dec. 19, 2002. The complete disclosure of that international patent application is incorporated into this application by reference.

### BACKGROUND OF THE INVENTION

1. Field of the Invention

The invention relates to a measuring method and also a measuring system for measuring the imaging quality of an optical imaging system. A preferred area of application is the measurement of projection objectives for microlithography.

2. Description of the Related Art

Microlithographic projection exposure apparatuses are used for fabricating semiconductor components and other finely structured devices. In this case, a pattern of a mask or of a reticle is imaged onto a substrate covered with a light-sensitive layer, for example a wafer, with the aid of a projection objective. The finer the structures to image, the greater the degree to which the quality of the products produced is determined and limited by imaging errors of the optical imaging systems used. Said imaging errors influence for example the imaged linewidths and the image position of the imaged structures.

A high-precision determination of imaging errors is a crucial step in the production process for optical imaging systems, in order to be able to provide systems having minimal imaging errors by means of suitable adjustment. Interferometric measuring methods are often used for this purpose. An apparatus for wavefront detection operating in the manner of a shearing interferometer, which enables a fast, high-precision measurement of extremely high resolution projection objectives, is described in the German Patent Application DE 101 09 929 (corresponding to US 2002001088 A1). In the case of this measuring system, a measuring mask that is to be illuminated with incoherent light and serves for shaping the coherence of the emerging radiation is arranged in the object plane of the imaging system to be tested. Said mask may have a transparent carrier, for example made of quartz glass, on which a mask structure is applied, for example by coating with chromium. Typical structure dimensions of radiation-transmissive regions of said mask structure may be large relative to the wavelength of the measuring radiation used. This is also referred to here as a two-dimensional or two-dimensionally extended mask structure. A reference structure formed as a diffraction grating is arranged in the image plane of the imaging system. The superimposition of the waves generated by diffraction gives rise, against the diffraction grating, to an intensity distribution in the form of an interferogram, which is detected electronically with the aid of a spatially resolving detector and is evaluated with the aid of an evaluation device connected to the detector. Low- and higher-order imaging errors can be determined from the wavefront aberrations.

Another class of devices for wavefront measurement is point diffraction interferometers, which work with structures having openings of the order of magnitude of the measuring light wavelength used or less than the latter.

Other test methods, in particular for measuring the distortion of optical systems, are based on utilizing the Moire effect. In this case, an object pattern is arranged in the object plane of the test specimen, said object pattern comprising for example a multiplicity of parallel lines that form an object structure. Typical structure dimensions of object patterns which can be designed in the manner of gratings, for example, are large relative to the wavelength of the measuring radiation used, so that diffraction effects are generally negligible. A reference structure similar to the object structure is arranged in the image plane. The object structure and the reference structure are matched to one another in such a way that a superimposition pattern (an intensity distribution) in the form of a Moiré pattern with Moiré fringes arises when the object structure is imaged onto the reference structure with the aid of the imaging system. From the intensity distribution of the fringe pattern, which can be detected electronically by means of a spatially resolving detector, it is possible to ascertain imaging parameters, in particular for the distortion of the imaging system. Moiré methods are disclosed for example in the patent specifications U.S. Pat. No. 5,767,959 and U.S. Pat. No. 5,973,773 or EP 0418054.

Since the imaging quality of optical high-performance systems is also critically dependent on ambient influences, such as temperature, pressure, mechanical stress and the like, it is also imperative, at the site of use when employed by the customer, to effect a monitoring of the imaging quality and also, if appropriate, an aberration control through manipulations on the imaging system. This requires availability of reliable, sufficiently precise measuring methods that permit a fast measurement of the projection objectives in-situ, i.e. in the incorporated state in a wafer stepper or wafer scanner.

U.S. Pat. No. 5,828,455 describes a measuring method that permits an in-situ wavefront measurement of projection objectives. The measuring method is based on a Hartmann test and requires a complex special reticle with a perforated plate having a plurality of holes and an aperture plate fitted behind the latter; the structures of the special reticle are exposed onto a wafer coated with photoresist. The construction of the reticle has the effect that a local tilting of the wavefront is converted into a distortion in the image plane. The exposed wafer is evaluated by measuring the structures outside the projection exposure apparatus using a scanning electron microscope (SEM) or other microscope-based inspection devices. The measuring light of the method is provided by the illumination system of the projection exposure apparatus. The measuring method affords sufficient measuring accuracy for most applications. However, since a large part of the illumination light is masked out at the special reticle, extremely long exposure times result for the wafer. The evaluation of the exposed wafer is costly in respect of apparatus and time.

There are other in-situ measuring methods involving carrying out in each case measurements at different numerical apertures and different illumination settings (multiple illumination settings, MIS). It is possible to differentiate here between aerial image measurements and MIS profile measurements. Quotations from articles on aerial image measurements are specified in U.S. Pat. No. 5,828,455. One resist-based in-situ measuring technique is the so-called aberration ring test (ART) described for example in U.S. Pat. No. 6,368,763 B2. In the aberration ring test, an annular object is imaged into the image plane of the projection objective. The deformations that can be measured at the imaged object with regard to ring diameter and ring shape in a focal series are detected by means of an extremely high resolution scanning system and subjected to a Fourier analysis, from which Zernike coefficients can then be derived. The method is time-consuming. The accuracy of the results is dependent on underlying model assumptions.

### SUMMARY OF THE INVENTION

It is one object of the invention to provide a measuring method and a measuring system which permit a high-precision measurement of optical imaging systems at the site of use thereof with a low outlay in respect of time and a low complexity in respect of apparatus. It is another object to enable a fast and precise measurement of projection objectives in microlithography projection exposure apparatuses of various designs.

To address these and other objects, the invention, according to one formulation thereof, provides a measuring method for measuring the imaging quality of an optical imaging system, which includes: providing a mask structure in the region of an object surface of the imaging system; providing a reference structure adapted to the mask structure in the region of an image surface of the imaging system; providing at least one two-dimensionally extended, radiation-sensitive recording medium in a recording position; imaging the mask structure onto the reference structure for generating an intensity distribution in the region of a field surface or a pupil surface of the imaging system; detecting the intensity distribution or an image of the intensity distribution with the aid of the recording medium; moving the recording medium from the recording position into an evaluation position remote therefrom; evaluating the recording medium remote from the recording position.

Advantageous developments are specified in the dependent claims. The wording of all current claims is hereby made part of the description by reference.

The invention makes use of the fact that the original information required for determining aberration parameters or the like is present in a spatial intensity distribution which is stored in latent fashion or permanently in the recording medium during the measuring operation. Said spatial intensity distribution is also referred to hereinafter as superimposition pattern. The detection of the intensity distribution or of the superimposition pattern (or of an image thereof) with the aid of the recording medium is also referred to hereinafter for short as “recording” of the intensity distribution or of the superimposition pattern or as “recording”.

The recording medium may be for example a film, photographic paper, photoresist or some other radiation-sensitive registration medium in which the image information of the intensity distribution is stored by means of chemical or chemical-physical processes. The use of light-sensitive, spatially resolving memory chips as a recording medium would also be conceivable.

It is also possible to use recording media in which a change in the ordered state of the recording medium due to the impinging radiation is utilized for storing the intensity distribution (or the superimposition pattern). By way of example, it is possible to utilize a change in the degree of magnetization of a magnetizable recording medium. The recording medium may comprise for example a film or a layer having homogeneously pre-magnetized ferromagnetic material, for example in the form of incorporated ferromagnetic crystals. In a manner similar to that in the case of audio tape or video material, the magnetization of the material may be predominantly unidirectional prior to the recording. Due to the impinging radiation (photo-electric effect) and/or due to local, radiation-induced heating (absorption), the ordered state of the material, i.e. the degree of alignment of the elementary magnets, can change locally depending on the quantity of radiation. The intensity distribution of the superimposition pattern can thus be written in. During the evaluation operation, it is possible to use a read-out device which, analogously to a magnetic read head of a video recorder, reads out the ordered state of the recording medium and converts it into an analog or digital signal. With knowledge of the transfer function, it is possible to construct the intensity distribution.

It is also possible to use a recording medium with variable polarization properties in order to record the superimposition pattern. By way of example, the recording medium may comprise a stretched plastic film that transmits only a selected radiation component having a specific direction of polarization. During the recording, the ordered state of the film can change locally due to the photoelectric effect and/or radiation absorption, so that the degree of polarization also changes locally in accordance with the quantity of radiation. A spatial intensity distribution can thereby be coded. The evaluation may be effected for example with the aid of a light table or the like, the exposed recording medium being superimposed with a suitable analyzer, for example a second polarization film, such that the preferred orientations thereof are rotated e.g. by 90° with respect to one another. In transmissions, the “exposed”, that is to say depolarized, zones may then appear bright and the “unexposed” zones may appear dark. This pattern can be digitized using optoelectronic means and be fed for further evaluation. In many cases, it may be favorable to use a suitable lithographic photoresist as recording medium. Particularly in measuring methods, such as the multiple fringe method, in which local distortions or phase deviations are registered as fringe bending, that is to say as a lateral offset from an ideal fringe position or as a local fringe deformation, it is also possible to utilize resist materials which do not resolve any gray shades, but rather essentially operate in “digital” or “binary” fashion and thus only register the states “bright” and “dark”. Since dealing with photoresist is a familiar technology in semiconductor fabrication, many of the resists are insensitive to ambient light, the handling of such resists is mastered and the spinning-on of such resists onto substrates and also the exposure and development thereof and the read-out of resist structures on evaluation tools are well-mastered standard techniques, the use of photoresists as recording media may be particularly advantageous from practical stand-points.

The recording medium is normally arranged behind the reference structure in the radiation path. There are also variants in which the reference structure is integrated into the recording medium. It is also possible to provide one or more reflections between passing through the reference structure and impinging on the recording medium. By way of example, a mirror layer may be provided which is fitted to the rear side of a transparent substrate at a distance behind the reference structure. In this case, the recording medium may be arranged in the region of the reference structure.

After the recording medium has been “exposed” during the measuring operation or during part of the measuring operation, it can be removed from the recording position and be evaluated outside the optical arrangement to be tested. The transporting of the basic information for the evaluation is thus not exclusively effected in line-conducted fashion, e.g. electronically, but rather encompasses the removal of the recording medium from the recording position. The evaluation can be carried out close to the time of the actual measuring operation or with a relatively long time interval between it and the actual measuring operation. As soon as a sufficient number of superimposition patterns or intensity distributions have been detected, the recording medium can be removed from the region of the image surface of the imaging system, so that the latter can be utilized for its original task again, for example the exposure of wafers.

The mask structure and the reference structure are arranged “in the region” of surfaces that are optically conjugate with respect to one another. This means that a structure can be arranged exactly in the corresponding surface or in a manner slightly axially offset with respect thereto, that is to say at a suitable distance in the vicinity of the surface (defocused). The optimum position is dependent on the desired method variant. The surfaces that are optically conjugate with respect to one another, which are generally planar surfaces, are also referred to hereinafter as “object surface” or object plane and as “image surface” or image plane. The object surface in the sense of this application is that surface in the region of which the mask structure is arranged during the measurement, while the reference structure is situated in the region of the image surface. The object surface of the measurement may be identical with the object surface during the intended use of the imaging system, but it may also correspond to the image surface during the intended use. In other words: the measuring direction in the measuring method according to the invention may run in a manner corresponding to the through-radiation direction during use, but it may also run in the opposite direction.

The configuration of the reference structure is dependent on the desired measuring method. Shearing interferometry mentioned in the introduction normally involves using reference structures that act as diffraction gratings for the measuring radiation. Suitable grating constants may be chosen in a manner dependent on the desired diffraction angle, which in turn determines the spatial resolution of the method. Typical dimensions may be in the region of the wavelength of the measuring radiation or else greater than that by up to one order of magnitude or more. In the case of the Moiré technique, typical structure dimensions may be significantly greater, if appropriate also less, than the measuring radiation wavelength. In the case of point diffraction interferometry, the reference structure generally comprises at least one quasi-punctiform “hole” for generating a reference spherical wave and also significantly larger passage regions for a test specimen wave. The diameter of the hole or of the transmissive region is typically less than the measuring light wavelength.

The typical structure dimensions of the mask structure may be different depending on the measuring method. The shearing interferometer mentioned in the introduction preferably involves the use of mask structures in which typical dimensions of radiation-transmissive regions are large relative to the wavelength of the radiation used. Such mask structures are also referred to as “two-dimensional” mask structures; accordingly, two-dimensional wavefront sources are formed which are composed of a multiplicity of individual spherical waves whose sources lie infinitesimally close together in a passage region of the mask structure. In the case of the Moiré technique, the typical structure dimensions are likewise large with respect to the measuring light wavelength. It is also possible to use mask structures in which at least a portion of radiation-transmissive regions has typical structure dimensions in the region of the radiation wavelength used or less than the latter. This makes it possible to create quasi-punctiform wavefront sources for generating individual spherical waves (pinholes) such as are used in point diffraction interferometry (PDI).

In one development, provision is made of a sensor unit, which encompasses the reference structure and the recording medium with positionally correct spatial assignment with respect to one another. If the sensor unit is arranged in such a way that the reference structure essentially coincides with the image surface, then the recording medium is at the same time also arranged positionally correctly, e.g. at a distance behind the reference structure parallel to the latter. The sensor unit may be dimensioned and shaped in such a way that it can be introduced instead of an object to be exposed, such as a wafer, into a mount provided for said object. The sensor unit may for example essentially have the slice form of a wafer and be incorporated in place thereof into a wafer stage and be demounted again after the measurement. In this way, in a projection exposure apparatus, at the site of use thereof, it is possible to change between production configuration (for wafer exposure) and measurement configuration in a simple manner. All that is necessary for this purpose besides changing the sensor unit instead of the wafer is to bring a suitable measuring structure into the region of the object plane, e.g. by exchanging the reticle with the useful pattern, said reticle being used for the wafer exposure, for a measuring mask carrying the two-dimensional mask structure of the measuring system. A platform-independent measuring system is thus created.

In some of the measuring methods considered here, it is necessary, for ascertaining a sufficient volume of data, to record a plurality of intensity distributions or superimposition patterns, said superimposition patterns differing by virtue of the fact that relative phase steps are present between the mask structure and the reference structure (phase shifting). For this purpose, in one embodiment, a relative displacement is carried out between the mask structure and the reference structure in a displacement direction perpendicular to the optical axis of the imaging system in order to obtain a plurality of superimposition patterns with different phase angles. The superimposition patterns or images of the superimposition patterns are preferably detected with the aid of the recording medium in such a way that the individual evaluation patterns lie offset with respect to one another in the recording medium, and in particular do not overlap. An “evaluation pattern” is the form of the spatial intensity distribution (of the superimposition pattern) present in the recording medium e.g. a latent or direct image. Superimposition patterns generated temporally successively are thus converted into evaluation patterns which lie spatially offset with respect to one another. The latter, depending on the type of evaluation, may in turn be evaluated temporally in succession or, if appropriate, also in parallel with one another.

In order to obtain a lateral offset of evaluation patterns without mutual overlapping, one method variant provides for a joint displacement of the reference structure and the recording medium relative to the mask structure perpendicular to the optical axis, the displacement distance being an integral multiple of a periodicity length p of the reference structure plus a fraction Δφ of the periodicity length. A large lateral distance is thus provided in addition to the small displacement Δφ required for a phase shift. In this case, different regions of the reference structure are utilized during each recording of a superimposition pattern.

In another variant, a displacement of the recording medium relative to the reference structure perpendicular to the optical axis is performed between successive recordings of evaluation patterns. In this method variant, it is possible to always utilize the same region of the reference structure for the measurement. The exposure of adjacent, non-overlapping regions of the recording medium may be effected for example analogously to the exposure of a film in a 35 mm camera.

As an alternative to phase shifting methods, it is also possible to use suitable multiple fringe methods for the measurement. Basic principles of the multiple fringe method are known per se and can be gathered for example from the reference book “Optical Shop Testing” by D. Malacara. The multiple fringe method can be used for example when measuring distortion by means of the Moiré technique.

In multiple fringe methods, that is to say in methods with a carrier frequency having been set, the spatial resolution plays an important part in the detection of spatial intensity distributions of a superimposition pattern since the phase angles are calculated from relative positions of the fringe positions of fringes. The phase information is thus coded as a lateral offset of fringes. In electronic cameras that are currently available, pixel sizes of up to approximately 6-7 μm are typically achieved, which corresponds to a resolution of approximately 70-80 line pairs per mm. If, by contrast, the information coded in the superimposition pattern is detected by means of a suitable spatially continuous recording medium, for example a suitable film or a photoresist layer, then resolutions of 400 lp/mm or more can readily be achieved even with typical standard materials. The higher spatial resolution capability and the absence of discretization of the information (non-pixelation) of film material and other continuous recording media is thus an advantage, precisely for the multiple fringe methods, over acquiring information with the aid of a CCD camera.

The measuring system may have a very compact, simple construction in the region of the reference structure. All parts required here may be combined in a sensor unit encompassing a reference substrate for carrying the reference structure and a recording carrier for carrying and/or supporting the recording medium. The reference substrate may be a plate made of a transparent material, in the case of which the reference structure is fitted to or in the vicinity of a plate surface. The recording carrier may likewise be a plate made of a transparent material and carry and/or support the recording medium on one of its plate surfaces. The reference substrate and the recording carrier may be formed by a single common plate of suitable thickness, which may essentially have the form of a wafer. It is also possible for the reference substrate and the recording carrier to be separate elements, for example two plates, which, if appropriate, can be brought into optical contact with one another along complementary contact surfaces, e.g. by wringing, and can be separated from one another. This embodiment enables a method variant in which the recording carrier is separated from the reference substrate after the measurement of the imaging system with the aid of the sensor unit. While the reference substrate with the possibly sensitive reference structure can remain at its location, the recording carrier can be brought to an evaluation device and the recording medium can be evaluated there. This reduces the risk of damage to the possibly expensive and sensitive reference substrate during different process steps and said reference substrate can be multiply reused. The recording carrier that carries the recording medium is generally less sensitive and can be provided inexpensively. The recording carrier may be a flexible film that carries the recording medium. The film can be pressed, adhesively bonded or fixed in some other way onto a planar or curved supporting surface for the recording and be removed after the recording.

The recording medium may be fixedly connected to the recording carrier, for example by adhesive bonding, vapor deposition, spinning-on, lamination or some other type of coating. The recording medium may be designed e.g. as a positive film or negative film. The recording medium may be formed by a photoresist layer applied directly to a transparent substrate.

It is possible to choose the recording medium such that the evaluation pattern is present in the recording medium directly after exposure in a form that can be processed further. It is also possible for a development step also to be interposed between the detection of the evaluation pattern and the subsequent evaluation, in order for example to convert a latent image into an image that can be evaluated. The recording medium may be permanently fixedly connected to the recording carrier. It is also possible for the recording medium to be designed for releasable fixing to a recording carrier. Finally, the recording carrier may also be assigned a displacement device for displacing the recording medium relative to the recording carrier, e.g. along a supporting surface of the recording carrier, in order for example to guide a film or the like along a plate surface.

In order to facilitate the evaluation, at least one auxiliary structure may be provided besides the reference structure and/or besides the pattern structure, said auxiliary structure being exposed together with the superimposition pattern into the recording medium during the measuring operation. Examples of auxiliary structures that are taken into consideration include registration marks for positionally correct arrangement of the recording medium and/or gray-scale value profiles for control or normalization of the resolved gray shades and/or line or cross gratings for imaging control by means of the Moiré technique and also combinations of these structures.

In one preferred method variant, the evaluation of the evaluation pattern present in or on the recording medium or of a development product thereof comprises an optoelectronic detection of the evaluation pattern or of a development product of the evaluation pattern for the purpose of generating digitally processable evaluation data and also a computer-aided evaluation of the evaluation data for the purpose of determining at least one imaging parameter representing the imaging quality. For the optoelectronic detection, it is possible to utilize an image-acquiring camera, for example, which can simultaneously detect many locations of the evaluation pattern in a two-dimensionally extended region by means of image acquisition. It is also possible to use a scanner which detects the evaluation pattern temporally successively along lines and feeds it for further evaluation. In the case of magnetic recording media, it is possible to utilize a reader having one or more magnetic read heads.

Any suitable evaluation method can be used for evaluating the evaluation data, for which reason evaluation methods will not be discussed in any greater detail here.

The invention can be utilized in various measuring techniques. By way of example, if provision is made of a reference structure which is adapted to the object structure in such a way that a Moiré pattern can be generated as a superimposition pattern when the object structure is imaged onto the reference structure, then it is possible to carry out arbitrary Moiré methods in the manner according to the invention. In this case, it is favorable if the recording medium is arranged in the vicinity of the image surface or in a conjugate surface with respect to the image surface. If an arrangement in the surface of the reference structure is not possible and the intention is to dispense with an optical imaging between reference structure and recording medium, then it is preferred for the recording medium to be arranged in the region of a Talbot surface of the reference structure. As is known, a self-imaging of the structure takes place depending on wavelength and structure dimensions at the so-called Talbot distance behind a grating structure. This circumstance can be utilized for generating superimposition patterns with only little blurring of the location information.

It is also possible to provide a reference structure which is effective as a diffraction grating for the radiation used during the measurement. Typical periodicity lengths are in this case in the region of the wavelength λ of the measuring light used, e.g. 1-20 λ or greater. In this case, it is preferred for a distance between the reference structure and the recording medium in the radiation propagation direction to be dimensioned such that the recording medium is arranged in the optical far field of the reference structure. Given a suitable mask structure, a coherent superimposition of laterally offset pupils and thus an interferogram arise as a superimposition pattern through the diffraction grating in the far field. It is also possible to arrange between the reference structure and the recording medium an optical system for imaging a pupil surface of the imaging system onto the recording medium. Such arrangements are also possible for point diffraction interferometry.

These and further features emerge not only from the claims but also from the description and the drawings, in which case the individual features may be realized, and may represent embodiments which are advantageous and which are protectable per se, in each case on their own or as a plurality in the form of subcombinations in an embodiment of the invention and in other fields. Exemplary embodiments of the invention are illustrated in the drawings and are explained in more detail below.

### BRIEF DESCRIPTION OF THE DRAWINGS

FIG. 1 is a schematic illustration of a first embodiment of a measuring system that operates in the manner of a shearing interferometer;

FIG. 2 is a schematic illustration of a first embodiment of a sensor unit for the measuring system shown in FIG. 1;

FIG. 3 is a schematic illustration of a second embodiment of a sensor unit for the measuring system shown in FIG. 1;

FIG. 4 is a schematic illustration of a third embodiment of a sensor unit for the measuring system shown in FIG. 1;

FIG. 5 is a schematic illustration of a recording medium with a multiplicity of interferograms arranged next to one another;

FIG. 6 is a schematic illustration of a detail from an exposed recording medium with an interferogram and a plurality of auxiliary structures exposed with the interferogram;

FIG. 7 is a schematic illustration of an embodiment of an evaluation device with a digital camera connected to an image processing computer and with a computer-controlled X/Y displacement table for a recording medium to be evaluated;

FIG. 8 is an exemplary embodiment of a reference structure with an inner checkerboard grating and outer line gratings for control of relative position and phase steps between mask structure and reference structures;

FIG. 9 is a schematic example of an evaluation pattern that can be generated with the aid of structures in accordance with FIG. 8;

FIG. 10 shows various Moiré patterns that may arise as a result of superimposition of line gratings;

FIG. 11 is a schematic illustration of a second embodiment of a measuring system for measurement by means of the Moiré technique;

FIG. 12 is a schematic illustration of a first exemplary embodiment of a sensor unit for use in a measuring system in accordance with FIG. 11;

FIG. 13 is a schematic illustration of a second embodiment of a sensor unit for use in a measuring system in accordance with FIG. 11;

FIG. 14 shows an example of a binary-prepatterned recording medium;

FIG. 15 shows an example of a sinusoidally prepatterned recording medium;

FIG. 16 shows a sensor unit with a sinusoidally patterned covering layer above a recording medium;

FIG. 17 shows a schematic illustration of an embodiment of a measuring system for point diffraction interferometry.

### DETAILED DESCRIPTION OF THE PREFERRED EMBODIMENTS

The invention is explained in more detail below using the example of the measurement of projection objectives for microlithography; however, it is also suitable for the measurement of other optical imaging systems, for example of photooptics or the like. FIG. 1 schematically shows a projection objective 10 designed for imaging with ultraviolet light, said projection objective being incorporated into a projection exposure apparatus (not illustrated) in the form of a wafer stepper at the production site of a semiconductor chip manufacturer. The projection objective 10 serves for imaging a pattern—arranged in its object plane 11—of a reticle provided with a useful pattern into the conjugate image plane 12 with respect to the object plane, on a reduced scale without an intermediate image. A semiconductor wafer covered with a photoresist layer is situated there. Located between object plane and image plane are a plurality of lenses, two of which are shown by dashed lenses, and a pupil plane 13, in which an aperture diaphragm 14 is arranged. During the wafer exposure, the reticle is carried by a reticle holder 15 and the wafer is carried by a wafer holder 16. The reticle holder and the wafer holder are assigned computer-controlled scanner drives in order to move the wafer during scanning synchronously with the reticle perpendicular to the optical axis 17 of the projection objective in opposite directions. The ultraviolet light for the projection is provided by an upstream illumination system 18.

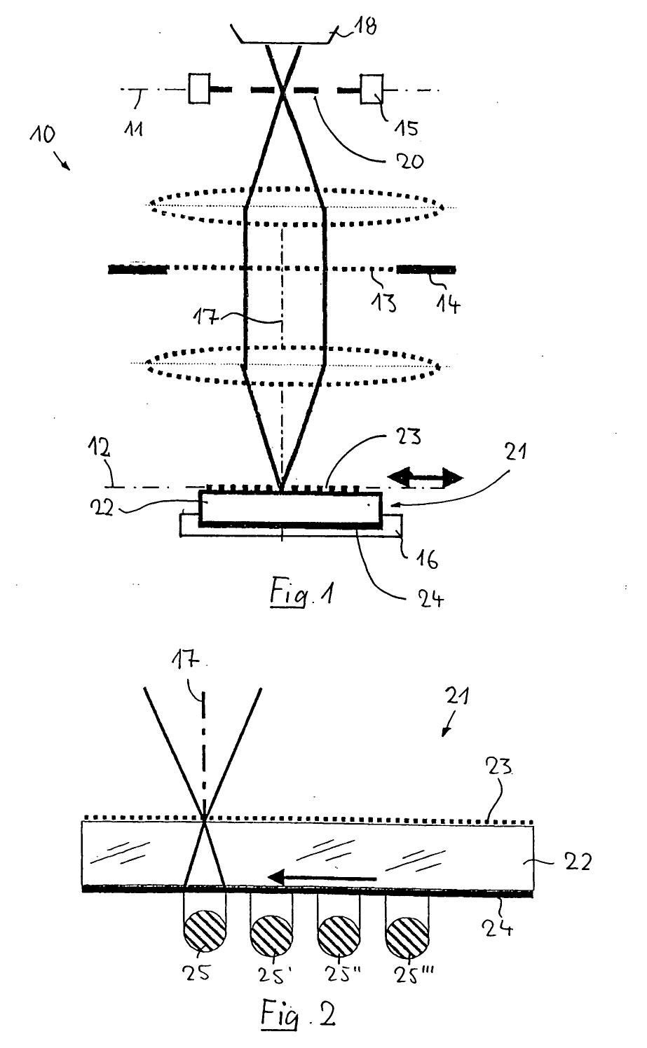

FIG. 1 shows the projection objective 10 in a measuring configuration, in which it can be interferometrically measured in situ, i.e. at its site of use in the incorporated state, with the aid of an embodiment of a measuring system according to the invention. The measuring system comprises a measuring mask, which has a mask structure 20 and can be arranged in exchange for the reticle provided with a useful pattern in the reticle holder 15 in such a way that the mask structure essentially coincides with the object plane 11. Furthermore, the measuring system comprises a sensor unit 21, which is illustrated in enlarged fashion in FIG. 2 and essentially has the round slice form of a wafer and can be inserted into the wafer holder 16 with an accurate fit in exchange for a wafer. The mobile sensor unit 21 of the exemplary embodiment comprises a substrate 22 in the form of a plane-parallel plate that is produced from synthetic quartz glass. A reference structure 23 in the form of a diffraction grating comprising chromium lines is applied on the planar top side of the quartz wafer 22, said reference structure being adapted to the mask structure. A two-dimensionally extended, radiation-sensitive recording medium 24 is applied on the opposite, planar plate surface of the quartz wafer 22, which recording medium is also referred to hereinafter as registration medium and is fixedly connected to the substrate 22. The radiation-sensitive material of the recording medium 24 formed as a photoresist layer is sensitive to the ultraviolet light of the illumination system 18, but is essentially insensitive to light from the visible wavelength region. The thickness of the substrate 22 is dimensioned such that, when a sensor unit 21 has been inserted into the wafer holder, the reference structure 23 essentially coincides with the image plane 12 of the projection objective and the recording medium is arranged in a recording position, which lies, in the light propagation direction, at a distance behind the reference structure in the optical far field of the diffraction grating 23.

In the case of the example, the mask is configured as a perforated mask having a symmetrical distribution of holes, the extent of which is in each case large with respect to the wavelength used. Examples of suitable two-dimensional mask structures are described in DE 101 09 929. The disclosure content of this publication is made the content of this description by reference. In the event of illumination with the aid of the illumination system 18, the mask structure 20 acts as a wavefront source for generating wavefronts which pass through the optical imaging system 10 and, in the normal case, are distorted by said imaging system with the generation of wavefront aberrations before they impinge on the diffraction grating 23. In this case, the optical system 10 images the structure of the wavefront source 20 onto the diffraction grating 12. In this case, the spatial structure of the wavefront source serves for shaping the spatial coherence of the wavefront. In the case of the shearing interferometry that is thereby possible, in principle different locations of the pupil 13 of the imaging system 10 are compared interferometrically with one another, for example by the light of a zeroth order of diffraction that passes through the diffraction grating 23 undiffracted being superimposed with the light of the first orders of diffraction for the purpose of forming a superimposition pattern in the region of the recording medium 24. In this way, an interferogram 25 (superimposition pattern) arises during the exposure in the region of the recording medium 24, said interferogram in this case also being referred to as an evaluation pattern and containing basic information about aberrations of the optical system 10.

In this embodiment of the measuring method, determining the wavefront requires a plurality of recordings, i.e. a plurality of interferograms, the interferograms differing by virtue of the fact that in each case relative phase steps lie between the imaged mask structure 20 and the diffraction grating 23 (phase shift). For this purpose, the sensor unit 21 is displaced stepwise perpendicular to the optical axis 17 with the aid of the drive of the wafer stage 16 between successive recordings. As an alternative, with a stationary reference structure, it is also possible for the mask structure to be moved by means of the reticle stage. The phase steps between the recordings in each case amount to fractions of the grating period p of the diffraction grating, for example Δφ=1/n·p, where φ denotes the phase step and p denotes the grating period, and n≧3. In the case of the example, the lateral movements of the sensor unit 21 are performed perpendicular to the optical axis 17 with the aid of the wafer holder 16 in such a way that the successively recorded interferograms 25, 25′, 25″ and 25′″ do not overlap and a relative phase step is additionally introduced. In this case, the displacement distance x between successive recordings (i.e. recordings of superimposition patterns in the recording medium) may be written for example as x=i·p+n·Δφ where i is an integer, n is the number of the phase step and Δφ is the magnitude of the phase step. It is also possible to adapt the phase angle Δφ of grating patches. In this way, as indicated in FIG. 2, it is possible to generate interferograms 25 to 25′″ corresponding to different phase steps in each case at adjacent locations of the recording medium. Since, in this method, both the recording medium 24 and the reference structure 23 are displaced as a result of the displacement of the entire sensor unit, during each measurement in this case a different location of the reference structure 23 is used for measurement. This imposes high demands on the accuracy of the production of the reference structure 23, which may be produced microlithographically for example.

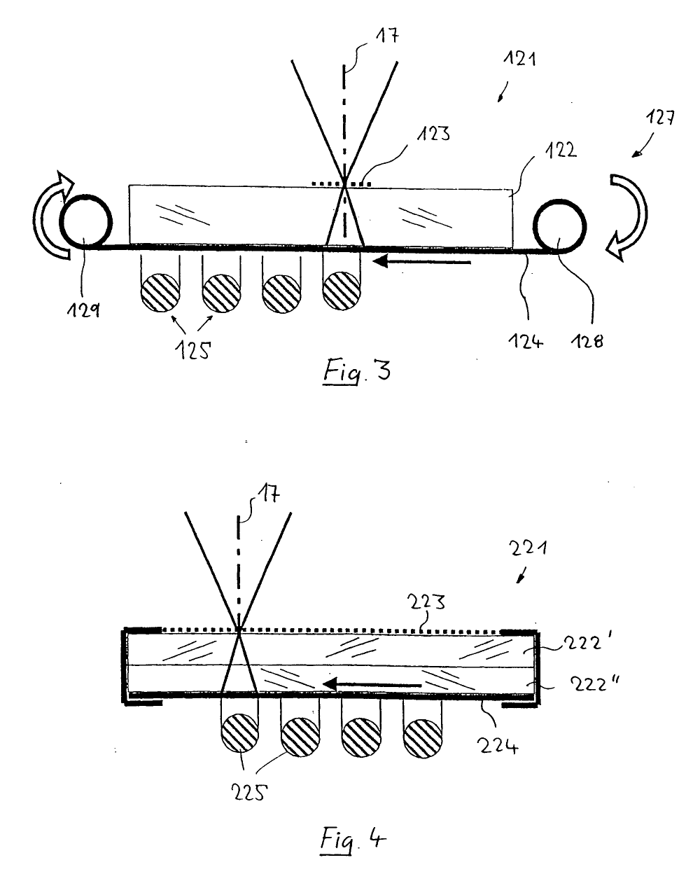

FIG. 3 shows another embodiment of a sensor unit 121, in which it is possible to always use the same grating location of the reference structure 123 for the purpose of generating adjacent interferograms 125 in a recording medium 124. This embodiment comprises a quartz substrate 122 formed as a plane-parallel plate, the reference structure 123 being fitted to the top side thereof in a relatively small region which, with the sensor unit incorporated, lies in the region of the optical axis 17. The recording medium 124, which may have the form of a self-supporting flexible film, is guided along the opposite, planar rear side of the substrate, said rear side carrying the recording medium in such a way that it is oriented parallel to the reference structure. In order to move the recording medium along the rear side of the substrate, provision is made of a displacement device 127 having a supply reel 128 and a take-up reel 129, which are rotated progressively by a drive (not shown) during the measuring operation in order temporally successively to bring different locations of the recording film 124 into the region of the optical axis 17 beneath the reference structure 123. In this embodiment, the supply reel, the drive for film transport and, if appropriate, a power supply that is not line-conducted are configured and arranged so compactly that the entire sensor unit 121 can be inserted into any commercially available wafer mount instead of a wafer. In particular for areas of use that impose less stringent demands on the measuring accuracy, this embodiment may be able to be realized inexpensively in a very simple manner by converting a 35 mm camera or the film transport mechanism thereof. The entire sensor unit can remain stationary during the phase shift. The phase shift can be carried out by shifting the mask structure with the aid of the reticle holder.

It is also possible for the recording medium to be applied directly, that is to say without an intermediate carrier, to a suitable surface of the substrate. By way of example, a layer made of photoresist may be spun on or a light-sensitive silver layer may be applied by vapor deposition. The recording medium can be applied in such a way that it can easily be removed after the evaluation, for example by being washed away with a solvent. These steps can be carried out without damaging the reference structure. Reusable substrates are thus possible, so that the measurement can be carried out cost-effectively.

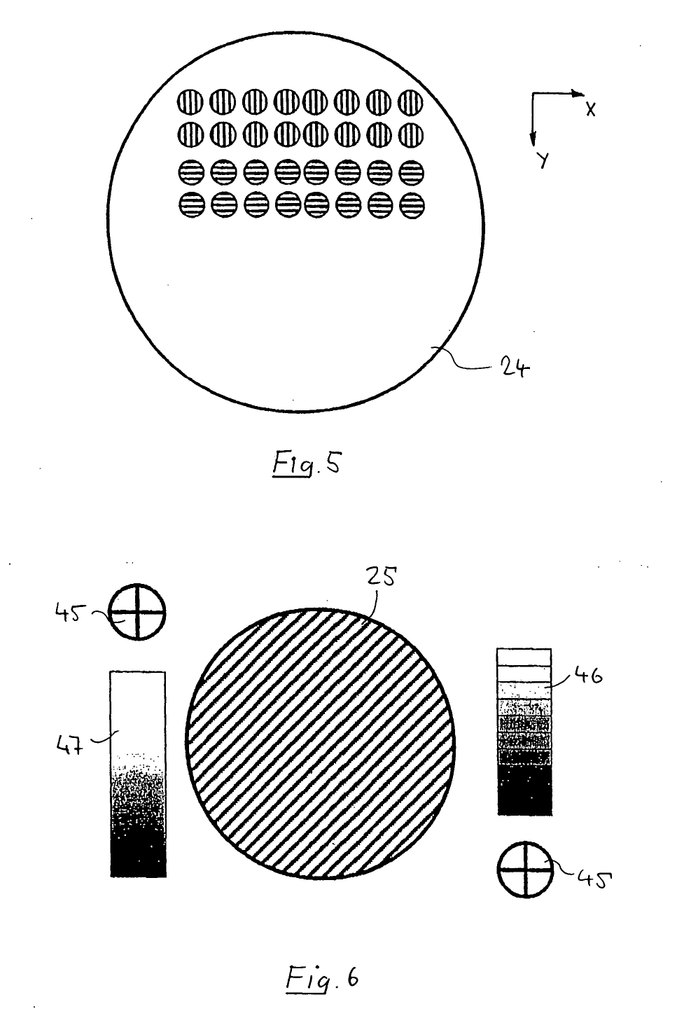

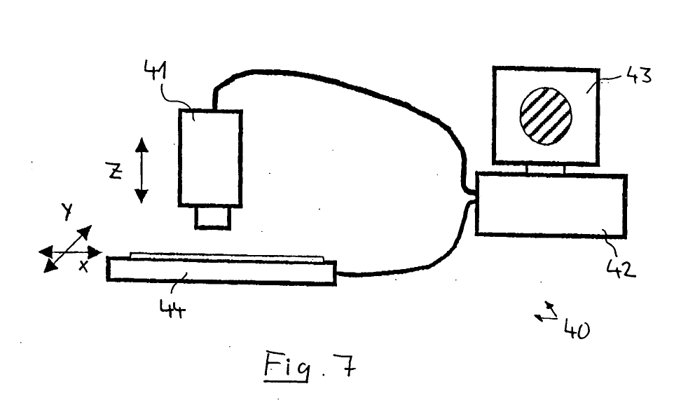

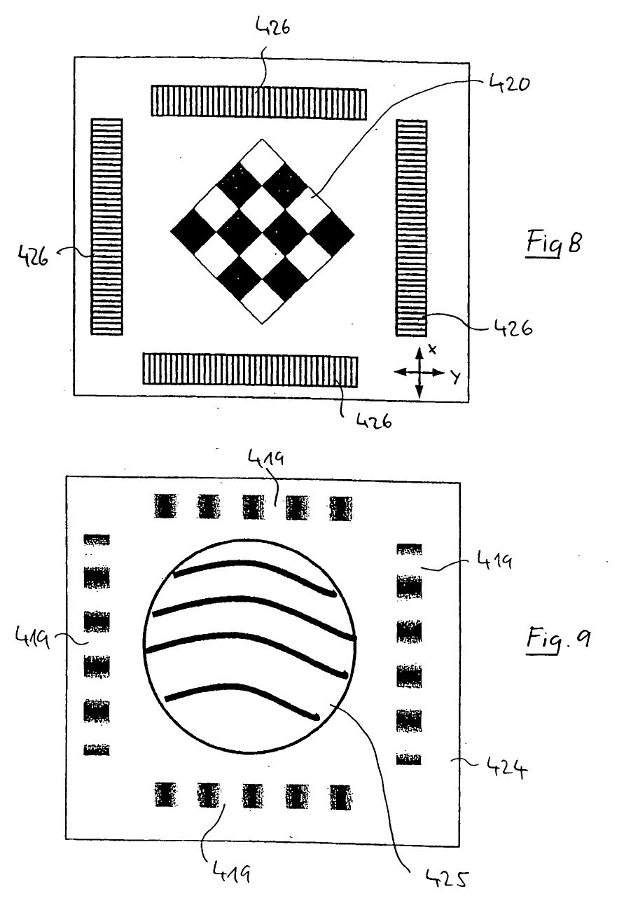

In the case of the sensor units 21, 121 in accordance with FIGS. 1 to 3, a single substrate is provided in the form of a quartz wafer, which serves as a reference substrate for carrying the reference structure and simultaneously as a carrier or substrate or supporting surface for the recording medium. In contrast to this, the third embodiment of a sensor unit 221 in accordance with FIG. 4 has a bipartite substrate comprising a reference substrate 222′ carrying the reference structure 223 and a film-carrying substrate 222″ serving as a recording carrier. The two substrates 222′ and 222″ in each case have the form of thin, wafer-type quartz plates and are connected to one another in a releasable manner with optical contact with respect to one another by wringing along planar contact surface. The thickness of the substrates 222′, 222″ is dimensioned such that the axial distance between reference structure 223 and recording medium 224 essentially corresponds to the thickness of the substrate 22 in accordance with FIG. 1. In the variant shown, the plates 222′, 222″ are fixed to one another with an additional clip at the peripheral region, but said clip may be obviated. The overall form of the sensor unit 221 corresponds to the form of a wafer, so that the sensor unit 221 can be inserted into a wafer holder 16 in exchange for a wafer. The bipartite releasable configuration of reference substrate 222′ and recording carrier 222″ reduces the risk of damage to the expensive and sensitive grating substrate 222′. The latter can be multiply reused in different process steps. After the recording medium 224 has been exposed with interferograms 225 during a measurement with different phase steps, the recording carrier 222″ can be stripped from the grating-carrying substrate 222′ and be brought to the evaluation device. For a further measurement, a recording carrier with an as yet unexposed recording medium can be wrung onto the reference substrate in the manner shown here in order to form a sensor unit 221 that can be used for a new measurement. The film-carrying substrate 222′ with recording medium 224 can be handled substantially more simply, when coating the substrate with the recording medium, than a substrate provided with a sensitive reference structure, so that the coating operation can be effected rapidly and inexpensively, for example by spinning-on or the like.

In all of the embodiments, suitable lateral displacement between recording medium and that region of the reference structure which is used for measurement, in the manner described, enables a multiplicity of interferograms corresponding to the different phase steps of the relative displacement to be arranged next to one another on or in a recording medium. The highly diagrammatic illustration (not to scale) in FIG. 5 shows by way of example the recording medium 24 with a plurality of adjacent interferograms 25, 25′, 25″ arranged in a regular, square grid. The illustration shows interferograms with a plurality of phase steps in the x direction and a plurality of phase steps in the y direction.

The image information contained in the exposed recording medium can be evaluated by the following procedure. Firstly, the recording medium with the measurement information contained therein is removed from the recording position in the wafer holder, for which purpose the entire sensor unit is normally removed. If the measuring mask is also removed from the reticle holder, the projection exposure apparatus is ready for further production. Depending on the type of recording medium, the evaluation pattern may be present in directly evaluatable form, for example in the form of a fringe pattern. The evaluation pattern present in latent fashion in the recording medium may also have to be developed chemically or in some other way. If the image information is present in optically evaluatable form in the recording medium, then the latter is brought into an evaluation position outside the projection exposure apparatus and evaluated there. For this purpose, the measuring system considered here comprises an evaluation device 40 illustrated schematically in FIG. 7. Said evaluation device comprises a digital camera 41, which serves as an optoelectronic detection device for detecting the evaluation patterns or development products of the evaluation patterns and for generating digitally processable evaluation data. The camera is connected to a computer 42, which contains, besides image acquisition devices, an evaluation program configured for determining at least one imaging parameter representing the imaging quality of the optical imaging system. A monitor 43 connected to the computer may be provided for displaying the images acquired by the camera 41 and, if appropriate, for displaying data serving for operator guidance and information. Moreover, a displacement table 44 is connected to the computer 41, and serves, by means of movements in the x or y direction, in each case to bring an interferogram to be detected into the image field of the camera 41, which can be adjusted along a perpendicular z direction for the purpose of focusing. In other embodiments, the camera can also be displaced in the x and y directions, so that an immobile depositing surface may serve for holding the recording medium 24. With these devices, the interferograms are read in in accordance with their assignment to field point, phase step and phase shifting direction and are evaluated with the aid of the evaluation program. The evaluation is not part of this invention and, therefore, is not explained in any greater detail. Possible evaluation routines are described for example in the reference book “Optical Shop Testing” by B. Malacara, 2nd Edition, John Wiley & Sons Inc. (1992).

As already mentioned, the shearing interferometry described here involves comparing different pupil locations interferometrically with one another. In order to be able to assign the associated pupil locations positionally correctly or with pixel accuracy, suitable auxiliary structures are present besides the interferograms in the recording medium (cf. FIG. 6). Said auxiliary structures can be introduced either by means of the exposure itself or in another way. In order to produce the auxiliary structures by means of the exposure itself, the mask structure and/or the reference structure can be assigned corresponding auxiliary structures, the effect of which will be explained later in connection with FIGS. 8 to 10. The auxiliary structures may be for example registration marks or reference marks 45 that permit a positionally accurate assignment of the various evaluation patterns that are to be calculated with one another. As an alternative or in addition, it is possible to provide auxiliary structures that permit the detection of effects of geometrical distortions that may arise e.g. during the processing of recording media. For control or for normalization of the resolved gray shades and of the exposure, neutral wedge filters or the like may also be included in the exposure, which may be formed either in stepped fashion (neutral wedge filter 46) or in continuous fashion (neutral wedge filter 47). These structures can improve the measuring accuracy that can be achieved by the method.

Reference will be made to FIGS. 8 to 10 in explaining how, in preferred embodiments, providing further auxiliary structures besides the mask structure and/or the reference structure makes it possible to check and, if appropriate, computationally correct phase step errors in the phase shifting. These structures may be formed in such a way that both the phase steps and a possible relative rotation of mask structure and reference structure can be detected and taken into account. The structures or the superimposition patterns thereof can be concomitantly exposed into the recording medium during the generation of the interferograms and be detected during the evaluation and used for the correction of evaluation errors. FIG. 8 shows an embodiment of a mask structure 420 in the form of a square checkerboard grating. Line gratings 426 running in the x and y directions are arranged outside the mask structure. The structured surface of an associated sensor unit has a similar construction with an inner checkerboard grating and outer line gratings. FIG. 9 shows an example of an intensity pattern which is generated in a recording medium 424 and arises when the mask is imaged onto the reference structure. An interferogram 425 arises as a superimposition pattern in the circular central region. The superimposition of the line gratings produces Moiré patterns 419 which extend in the x and y directions and lie outside the superimposition pattern 425.

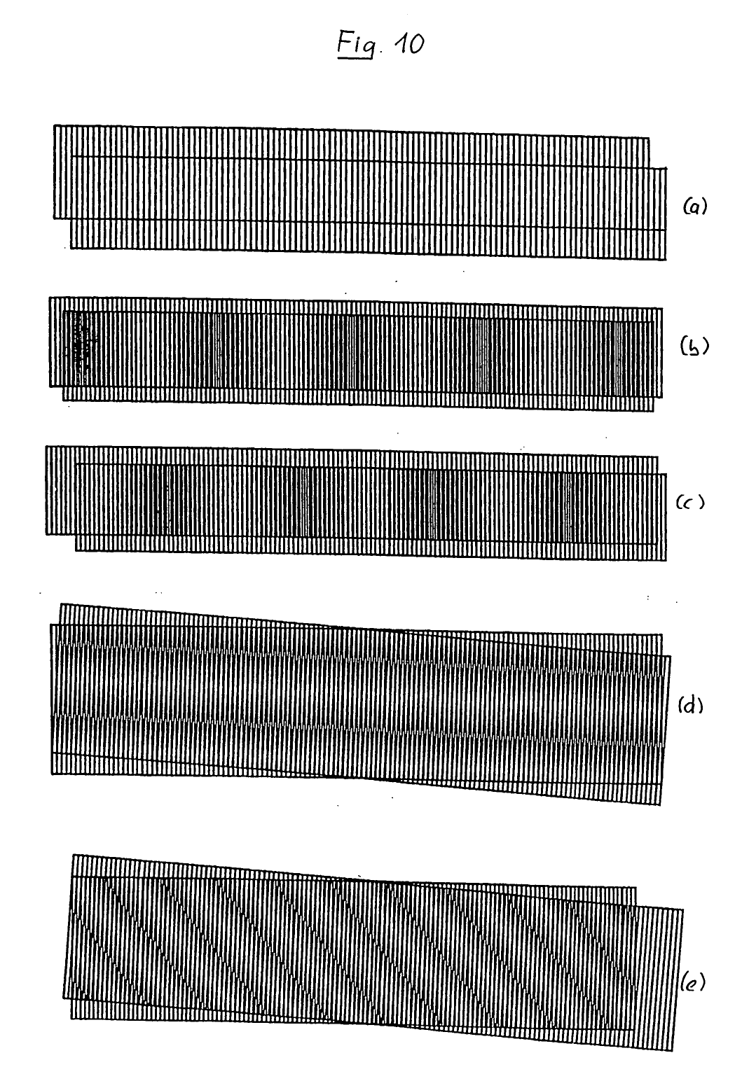

In order to explain the information content of Moiré patterns, reference is made firstly to FIG. 10, which shows, in subfigure (a), two superimposed line gratings having an identical period which run parallel to one another and therefore do not generate any Moiré fringes. In subfigure (b), the line gratings aligned parallel to one another have different periodicity lengths, thus giving rise to a sinusoidal fringe pattern. Subfigure (c) shows the Moiré fringes if a small relative lateral displacement of the two line gratings shown in Fig. (b) is effected parallel to the longitudinal direction of the gratings. In this case, the position of the Moiré fringes is displaced and the distance between them remains unchanged here. Subfigure (d) shows the result of a relative rotation of two line gratings with respect to one another. The resulting Moiré pattern is a fringe pattern perpendicular to the line direction of the line gratings. Finally, subfigure (e) elucidates a Moiré pattern that arises if line gratings having a different periodicity length (cf. (b)) are rotated relative to one another. This results in a Moiré pattern having oblique fringes, the line spacing of which represents a measure of the relative rotation.

On the basis of these explanations, the image information in FIG. 9 can be interpreted as follows. Identical phase angle of opposite Moiré patterns 419 means that the mask structure and the reference structure have no relative rotation, that is to say are perfectly adjusted with respect to one another. From the phase angle of the Moiré patterns, it is possible to determine the phase angle of the diffraction grating relative to the coherence-shaping mask with high precision. The focusing can be checked by means of the contrast of the Moiré pattern. The highest contrast is afforded when the mask structure and the reference structure or the associated line gratings lie exactly in conjugate planes. A tilting of the contrast profile would indicate that mask and diffraction grating were not aligned parallel to the object plane or image plane. On account of this additional information, the evaluation patterns can be evaluated with extremely high accuracy.

When using Moiré auxiliary gratings for control of phase shift and grating adjustment, the substrate thickness or the axial distance between the line grating beside the reference structure and the recording medium should essentially be adapted to a Talbot distance of the grating, at which a self-imaging of the grating takes place and a blurring of location information can thus be minimized. It is possible, if appropriate, to dispense with a diffusing screen and/or a fluorescent layer for reducing the spatial coherence.

In all of the embodiments, it is possible to provide separate measures for the protection of the recording medium, in order to protect this layer from mechanical damage, for example scratches, and/or from optical damage, e.g. due to extraneous exposure. For mechanical protection, protective layers may be provided which, however, must not impair the evaluation. In order to avoid extraneous exposure, it is possible to provide for the recording medium to be encapsulated by suitable cassettes or the like. It is particularly beneficial if the material used is sensitive essentially only or predominantly at the useful wavelength used during the measurements (typically in the ultraviolet region) and is insensitive in other wavelength ranges, for example in visible regions. This is advantageous particularly for use in wafer steppers since light-optical path length and positioning measuring systems are often used here, which often operate with laser light (e.g. 633 nm wavelength). In the grating layout, the surfaces between the partial gratings for measurement may be provided with a protective layer or a closed chromium layer over the whole area. A blocking layer, e.g. a bandpass filter, may be fitted to a surface in front of the recording medium in order to protect against false light and to simplify the handling in ambient light.

The measuring method is implemented here by way of example on the basis of a measurement using a single measuring channel for an individual field point. A simultaneous measurement is preferably carried out at a plurality of field points. The preconditions for carrying out such a multichannel measurement in the case of a shearing interferometer are described for example in DE 101 09 929. The disclosure content of this publication is made the content of this description by reference. If a parallel measurement is provided, this is to be taken into account in the design of the measuring sequence. The design of mask structure and reference structure in each case produces the spatial arrangement of the interferograms. The number of interferograms to be registered may remain the same given the same number of field points.

Another embodiment of a measuring system according to the invention is explained with reference to FIG. 11, which measuring system can preferably be utilized for fast high-precision measurement of distortion by means of the Moiré technique. The construction of the projection exposure apparatus corresponds to that of FIG. 1, for which reason the same reference symbols are used in this regard. The measuring system comprises a measuring mask with a mask structure 520, which is to be arranged in the object plane 11, and also a sensor unit 521 with a reference structure 523, which is to be arranged in the image plane 12 of the projection objective 10. The mask structure 520 is normally a line grating or a parquet pattern. The associated reference structure 523 is a similar grating with an identical pattern adapted in accordance with the imaging scale of the projection objective. The line widths typically correspond approximately to the resolution of the optical imaging system and may be in the micrometers range or less when measuring microlithographic projection objectives.

The superimposition of an image of the mask structure 520 with the reference structure 523 gives rise to a superimposition pattern that typically has the form of a fringe pattern. This pattern is detected by a corresponding recording medium 524 directly or with the interposition of a frequency converter layer. The distortion can be determined from the form of the Moiré pattern produced by superimposition. For exactly determining the relative phase angle it is possible, in a similar manner to that in the case of the interferometric procedure described, to use a phase shifting method in order to obtain superimposition patterns or evaluation patterns with different phase angles. In order to be able to determine the complete distortion vector, it is possible to carry out the recording using two grating structures that are preferably oriented orthogonally with respect to one another or using two-dimensional grating structures.

In order to carry out such a measuring method, the measuring system has the mask with the mask structure 520 and a sensor unit 521 with the reference structure 523 and the recording medium 524. The sensor unit 521 has the flat slice form of a wafer. The movements of mask structure and/or reference structure that are required for the phase shift are carried out by the moveable holders 15 and 16, respectively, of the projection exposure apparatus.

The sensor unit comprises a relatively thin substrate 522 composed of quartz glass, on one plate surface of which is applied the reference structure 523 and on the opposite plate surface of which is applied the recording medium 524 in the form of a thin film made of light-sensitive material. For mechanical stabilization of the arrangement, the entire arrangement is carried by a mechanically stable, thicker quartz plate 526. This plate, in other embodiments, may also be composed of nontransparent material, for example silicon. The thin substrate 522 is transparent to the measuring light, but it may also have a scattering effect and/or have frequency-converting properties. It may be composed for example of cerium-doped quartz glass. In the case of the Moiré technique, it is important for the recording medium 524 to be situated as close as possible to the reference structure or a conjugate plane with respect thereto. A high-contrast superimposition can be achieved despite distance from the reference structure when the recording medium, as in the embodiment shown, is arranged at a Talbot distance from the reference structure.

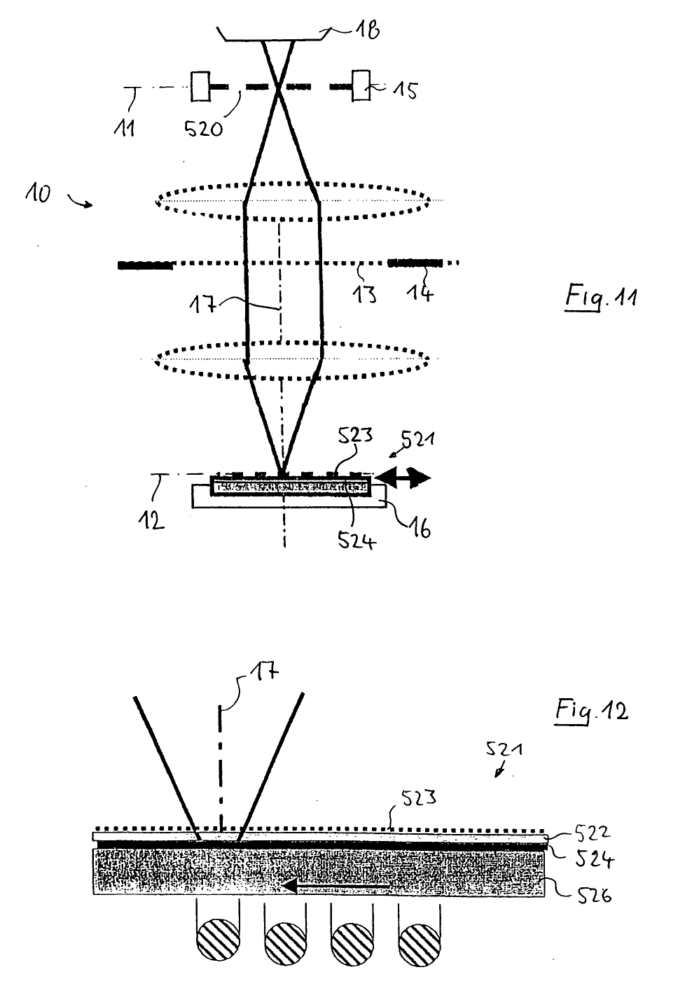

In the case of the arrangement shown, the recording medium 524 need not be fixed to the thin reference substrate 522. It is also possible to fix the recording medium on the stable carrier plate 526 and merely to place the reference substrate onto the recording medium. For fixing purposes, it is possible, if appropriate, to provide separate elements at the edge region of the sensor unit 521. It is also possible for the recording medium to be fixedly fitted to none of the substrates 522, 526. An embodiment which enables a relative displacement of the recording medium with respect to the reference structure is illustrated schematically in FIG. 13. The spatial sequence of reference structure 623, reference substrate 622, recording medium 624 and stable carrier plate 626 corresponds to the construction in FIG. 12. For the construction and functioning of the displacement device 627, reference is made to the description in connection with FIG. 3. Analogously to the embodiments in accordance with FIGS. 2 and 3, in the case of the embodiment in accordance with FIG. 12, between successive measurements, the entire sensor unit 521 is moved step by step with the aid of the wafer holder and different grating regions of the reference structure are successively utilized. By contrast, the embodiment in accordance with FIG. 13 permits an immobile arrangement of the sensor unit 621 since only the filmlike flexible recording medium 624 has to be moved relative to the reference structure. The same region of the reference structure is always utilized here, and said reference structure can be designed to be correspondingly small.

A recording medium exposed with the embodiment in accordance with FIG. 12 can be constructed, in principle, as shown in FIG. 5. During phase shifting, it is possible, by way of example, to detect 2*8 phase steps in the x direction and the same number of phase steps in the y direction. Given an image diameter of approximately 30 mm and a substrate diameter of 200 mm, it is possible, by way of example, to acquire approximately 30 Moiré images. This permits 15 phase steps in each case to be recorded for the x and y directions for the determination of the distortion. In the case of a wafer scanner, the image field used is rectangular, for example with 30 mm*15 mm. Approximately double the number of detected Moiré patterns is possible here.

For detecting and evaluating the evaluation patterns, it is possible to use an evaluation device analogously to the evaluation device 40 shown in FIG. 7, in which case a different operating program is to be used in the evaluation of Moiré patterns.

As an alternative to the method described with a temporal phase shift, it is also possible to use a variant known as a multiple fringe method. By rotating the grating orientation, a carrier frequency can be impressed on the Moiré pattern, so that this method can be used. The advantage consists in the fact that the phase distribution can be calculated from a single superimposition pattern (Moiré image); consequently, no phase shift is required. Suitable evaluation methods are described for example in.

In the case of the Moiré technique, too, it is possible to provide auxiliary structures analogously to the structures described in FIGS. 6 and 8 to 10 in order to enable extremely high precision in the evaluation.

In the case of the embodiments described hitherto, the recording medium is arranged in the light path at a distance behind the reference structure, the distance having to be adapted to the respective measuring method. Embodiments are also possible in which the reference structure is integrated into the evaluation medium in such a way that evaluation medium and reference structure have no or only a very small distance from one another. By way of example, by prepatterning the recording medium with a grating pattern, the recording medium can be brought directly into the plane of the reference structure. It is not necessary to destroy the spatial coherence in this case. The Moiré image arises here not through coherent superimposition of orders of diffraction behind the grating, but solely through intensity addition in the plane of the reference structure. The reference structure can be patterned differently, corresponding structure lines or grating lines can have different intensity profiles and different ways of producing such patterned recording media are possible. Examples of typical basic patterns are line gratings, cross gratings, parquet gratings or checkerboard gratings. Other grating forms, for example combinations of the grating types mentioned, are also possible. The intensity profiles may be configured in binary fashion, i.e. in abrupt fashion, or in gray shades. As an example, FIG. 14 shows a plan view of a registration medium 724 that is prepatterned or preexposed in binary fashion, for example a photoresist or a film, in the case of which there is a rectangular light-dark profile perpendicular to the lines. The material of the recording medium may for example be exposed through to saturation or removed at the bright locations and be radiation-sensitive only at the unexposed interspaces. Intensity profiles in gray shades are also possible, for example the sinusoidal intensity profile of a registration medium 824 as shown in FIG. 15. Such patterned recording media can be produced for example by preexposing a grating pattern into the recording material. Production is also possible by means of a contact print from a master original, which may be formed by a chromium grating, or by writing methods. Locations, for example of a photoresist, that have been fully exposed can remain or be stripped out from the recording medium. For the purpose of patterning by means of ablation, it is also possible to use techniques customary in lithography e.g. a coating of the layer to be patterned with a binary resist, the exposure thereof, development and etching in of the structure. In order to produce a structure with gray shades, it is possible for example to carry out an exposure with targeted unsharpness or with the aid of a low-pass filtering of the imaging. It would also be possible to effect the imaging through a projection objective, in which case the numerical aperture thereof would have to be correspondingly adapted to the structure dimensions. This has the advantage inter alia, that the geometry errors of the written-in grating would be known precisely since distortion errors of the objective and errors of the grating original can be determined from the outset. High-precision sinusoidal linear gratings can also be produced holographically by coherent superimposition of planar waves.

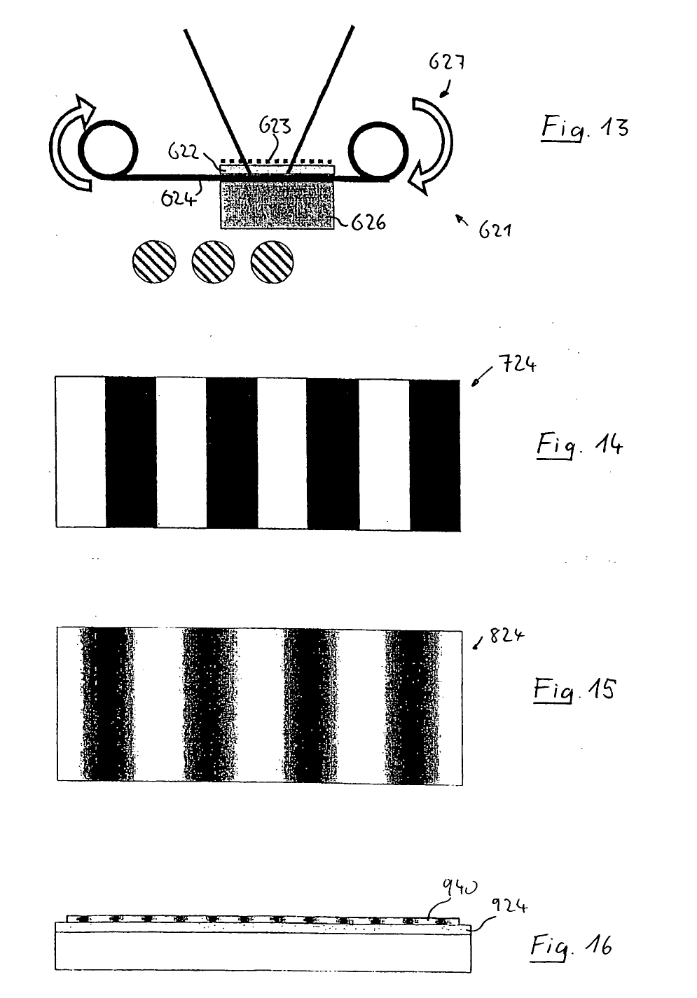

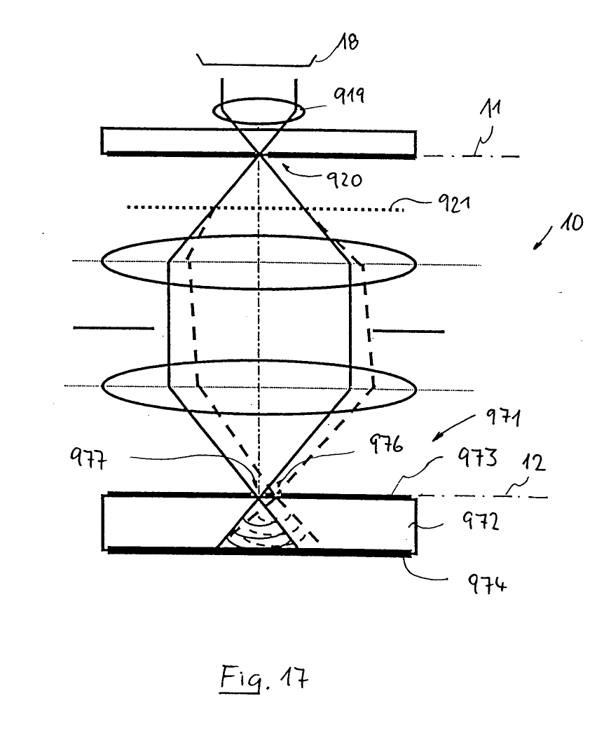

With reference to FIG. 16, the illustration shows that it is also possible to produce a prepatterned recording medium or a recording medium in direct proximity to a reference structure by applying a thin, patternable or already patterned reflection or absorber layer 940 directly on a layer of the recording medium 924 e.g. by lamination.

A further variant of a measuring method and measuring system according to the invention is explained with reference to FIG. 17. FIG. 17 schematically shows the construction of a mobile, phase-shifting point diffraction interferometer. An illumination optical element 919 downstream of the illumination device 18 serves for focusing light onto a perforated mask 920, which serves as a mask structure and is arranged in the object plane 11 of a projection objective 10 to be measured. The diameter of the hole in the mask structure is less than the wavelength of the measuring light and thus serves to generate a spherical wave (solid line) by diffraction. A diffraction grating 921 between perforated mask 920 and projection objective 10 serves for generating a second wave (depicted in dashed fashion), which is coherent with respect to the first spherical wave, and for the phase shifting that is possibly used. As an alternative, the diffraction grating may also be arranged between the projection objective and the image plane thereof. The reference structure 973 to be arranged in the image plane 12 of the projection objective is likewise formed as a perforated mask. It has at least one quasi-punctiform hole 976 that serves for generating a reference spherical wave by diffraction. Its diameter is less than the measuring light wavelength. Arranged beside that is (at least) one larger hole 977, the diameter of which is significantly greater than the measuring light wavelength and which serves as spatial delimitation of the test specimen wave shown by solid lines. The reference structure 973 is arranged on a planar top side of a transparent substrate 972. A radiation-sensitive recording medium 974, for example in the form of a resist layer made of photoresist, is applied to the opposite side of the sensor unit 971. The axial distance between reference structure 973 and recording medium 974 is dimensioned such that the recording medium is situated in a region in which superimposition of the reference wave coming from the hole 976 and of the test specimen wave that passes through the hole 977 gives rise to an interference pattern (superimposition pattern) containing information about the imaging quality of the projection objective. The interference pattern is stored in the layer 974 and, analogously to the manner described above, after removal of the sensor unit 971 can be detected by a camera and the like and be evaluated.

An explanation has been given on the basis of exemplary embodiments that the invention provides possibilities for carrying out e.g. high-precision wavefront measurements by means of shearing interferometry or by means of point diffraction interferometry or high-precision measurements by means of the Moiré technique on projection objectives that are incorporated into a projection apparatus at their site of use. The measurements are possible independently of the type of projection exposure apparatus and thus in a platform-independent manner. For this purpose, mobile sensor units are preferably used which encompass a reference structure and a recording medium and can be inserted into the wafer stages instead of a wafer. These manipulation devices that can be moved with high precision can be utilized for possibly required displacements of the reference structure possibly without modification. The measuring technique does not require, at the projection exposure apparatus, any optoelectronic image acquisition devices that operate for example with a CCD camera and, if appropriate, imaging optics. Consequently, a universally usable measuring system is created which permits extremely high-precision measurements despite a simple construction of its components.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. A measuring method for measuring the imaging quality of an optical imaging system, comprising:
providing a mask structure in the region of an object surface of the imaging system;
providing a reference structure adapted to the mask structure in the region of an image surface of the imaging system;
providing at least one two-dimensionally extended, radiation-sensitive recording medium in a recording position;
imaging the mask structure onto the reference structure and generating an intensity distribution in the region of a field surface or a pupil surface of the imaging system;
detecting the intensity distribution or an image of the intensity distribution with the aid of the recording medium;
moving the recording medium from the recording position into an evaluation position remote from the recording position; and
evaluating the recording medium remote from the recording position.

2. The measuring method as claimed in claim 1, comprising:
providing a sensor unit, which includes the reference structure and the recording medium with positionally correct spatial assignment with respect to one another.

3. The measuring method as claimed in claim 1, wherein the following steps are carried out for the purpose of measuring a projection objective incorporated into a projection exposure apparatus:
exchanging a useful pattern used for the exposure of an object to be patterned for the mask structure of the measuring system in the region of the object surface of the imaging system;
exchanging an object to be patterned for a sensor unit, which includes the reference structure and the recording medium with positionally correct spatial assignment with respect to one another, the sensor unit being arranged in such a way that the reference structure is arranged in the region of an image surface of the imaging system.

4. The measuring method as claimed in claim 3, wherein exchanging the useful pattern for the mask structure comprises exchanging a reticle with the useful pattern, said reticle being used for the exposure of an object to be patterned, for a measuring mask carrying the mask structure of the measuring system.

5. The measuring method as claimed in claim 1, wherein, for the purpose of generating a plurality of spatial intensity distributions with different phase angles (phase shifting), a relative displacement is carried out between the mask structure and the reference structure in a displacement direction perpendicular to an optical axis of the imaging system.

6. The measuring method as claimed in one of claims 1, wherein a multiple fringe method is carried out.

7. The measuring method as claimed in claim 1, wherein intensity distributions or images of intensity distributions are detected with the aid of the recording medium for the purpose of generating evaluation patterns in such a way that the evaluation patterns lie offset with respect to one another in the recording medium.

8. The measuring method as claimed in claim 7, wherein a joint displacement of the reference structure and the recording medium relative to the mask structure perpendicular to the optical axis is carried out between successive generations of evaluation patterns.

9. The measuring method as claimed in claim 7, wherein a displacement of the recording medium relative to the reference structure perpendicular to the optical axis is carried out between successive recordings.

10. The measuring method as claimed in claim 1, further comprising:
providing a reference substrate for carrying the reference structure;
providing a recording carrier for carrying the recording medium, the recording carrier being separate from the reference substrate;
arranging the reference substrate and the recording carrier in a positionally correct manner, for forming a sensor unit;
measuring the imaging system with the aid of the sensor unit;
separating the recording carrier with the recording medium from the reference substrate; and
moving the recording carrier with the recording medium from the recording position into an evaluation position remote from the recording position.

11. The measuring method as claimed in claim 1, further comprising:
fitting a layer of a recording medium to a surface of a substrate which carries the reference pattern or is arranged in a positionally correct arrangement with respect to the reference structure;
detecting superimposition patterns with the aid of the recording medium and evaluating the recording medium;
stripping the recording medium from the substrate; and
reusing the substrate for fitting a recording medium.

12. The measuring method as claimed in claim 1, wherein the recording medium comprises at least one layer made of radiation-sensitive resist.

13. The measuring method as claimed in claim 1, wherein the recording medium contains at least one material which experiences one of a permanent and a reversible change in its ordered state upon irradiation with measuring radiation.

14. The measuring method as claimed in claim 1, wherein the evaluation comprises:
detecting at least one evaluation pattern or a development point of the evaluation pattern for the purpose of generating digitally processable evaluation data;
evaluating the evaluation data in computer-aided fashion for the purpose of determining at least one imaging parameter representing the imaging quality of the imaging system.

15. The measuring method as claimed in claim 14, wherein at least one optoelectronic device is used for detecting spatial variations of optically perceptible properties of the recording medium.

16. The measuring method as claimed in claim 14, wherein at least one device that is selective with respect to the degree of order is used for detecting spatial variations of an ordered state of the recording medium.

17. The measuring method as claimed in claim 1, further comprising:
providing a reference structure which is adapted to the mask structure in such a way that a Moiré pattern is generated as a superimposition pattern when the mask structure is imaged onto the reference structure; and
providing the recording medium in the region of the image surface or a conjugate surface with respect to the image surface or in the region of a Talbot surface of the reference structure.

18. The measuring method as claimed in claims 1, further comprising:
providing a reference structure which is effective as a diffraction grating for the radiation used during the measurement; and
providing the recording medium in the region of a surface in which it is possible to detect, as a superimposition pattern, an interferogram from radiation of different orders of diffraction of the diffraction pattern.

19. The measuring method as claimed in claim 1 comprising:
providing a reference structure which has at least one quasi-punctiform passage for the radiation used during the measurement; and
providing the recording medium in the region of a surface in which it is possible to detect, as a superimposition pattern, an interferogram from radiation coming from the passage and radiation coming from the mask structure through the imaging system.

20. The measuring method as claimed in claim 18, wherein the recording medium is arranged in the optical far field of the reference structure.

21. The measuring method as claimed in claim 1, further comprising a frequency conversion of the radiation used for the measurement into a frequency range in which the recording medium is radiation-sensitive.

22. The measuring method as claimed in claim 1, wherein the measurement is carried out at a multiplicity of field points.

23. The measuring method as claimed in claim 22, wherein the measurement is carried out simultaneously at a multiplicity of field points.

24. The measuring method as claimed in claim 1, further comprising:
recording of at least one auxiliary structure in the recording medium in addition to at least one evaluation pattern.

25. The measuring method as claimed in claim 24, wherein the auxiliary structure is at least one of at least one registration mark, at least one neutral wedge filter and at least one line grating.

26. A measuring system for measuring the imaging quality of an optical imaging system, comprising:
at least one measuring mask with at least one mask structure for arrangement in an object surface of the imaging system;
at least one reference substrate with a reference structure adapted to the mask structure for arrangement of the reference structure in the region of the image surface in the imaging system;
at least one recording carrier with a two-dimensionally extended, radiation-sensitive recording medium for arrangement of the recording medium in a recording position,
an arrangement configured to move the recording medium from the recording position into an evaluation position remote the recording position; and
at least one evaluation device for evaluating the recording medium outside the recording position.

27. The measuring system as claimed in claim 26, further comprising at least one sensor unit, which encompasses the reference substrate with the reference structure and the recording carrier with the recording medium.

28. The measuring system as claimed in claim 27, wherein the sensor unit is dimensioned and shaped such that the sensor unit is introduced, instead of an object to be exposed, into a holder of a microlithography projection exposure apparatus, said holder being provided for the object.

29. The measuring system as claimed in claim 27, wherein the sensor unit essentially has the form of a semiconductor wafer.

30. The measuring system as claimed in claim 26, wherein the reference substrate is a plate made of a material that is transparent to the measuring radiation, and the reference structure is arranged on or in the vicinity of a plate surface of the plate.

31. The measuring system as claimed in claim 26, wherein the recording carrier is a plate and the recording medium is supported or carried by a plate surface of the plate.

32. The measuring system as claimed in claim 26, wherein the reference substrate and the recording carrier are formed by the same element.

33. The measuring system as claimed in claim 32, wherein the same element is a plane-parallel plate.

34. The measuring system as claimed in claim 26, wherein the reference substrate and the recording carrier are elements configured to be separated from one another.

35. The measuring system according to claim 34, wherein the reference substrate and the recording carrier are designed for being brought into optical contact along complementary contact surfaces.

36. The measuring system as claimed in claim 26, wherein the recording medium is fixedly connected to a surface of the recording carrier.

37. The measuring system according to claim 26, wherein the recording medium is fitted to a surface of the recording carrier as a layer that is stripped away.

38. The measuring system as claimed in claim 26, wherein the recording medium is designed for at least one of releasable fixing to the recording carrier and moving relative to the recording carrier.

39. The measuring system as claimed in claim 26, wherein the recording carrier is assigned a displacement device for displacing the recording medium relative to the recording carrier.

40. The measuring system as claimed in claim 26, wherein at least one auxiliary structure for arranging in the region of the image surface of the imaging system is arranged besides the reference structure.

41. The measuring system according to claim 40, wherein the auxiliary structure is at least one of at least one registration mark, at least one neutral wedge filter and at least one line grating which is adapted to a line grating of the measuring mask for generating a Moiré pattern.

42. The measuring system as claimed in claim 26, wherein the recording medium is arranged at a distance from the reference structure such that, in a measuring configuration, the recording medium is arranged at a distance behind the reference structure in the radiation path.

43. The measuring system as claimed in claim 42, wherein the distance is dimensioned such that the recording medium is arranged in the optical far field of the reference structure.

44. The measuring system as claimed in claim 43, wherein the distance is dimensioned such that the recording medium is arranged in the region of a Talbot surface of the reference structure.

45. The measuring system as claimed in claim 42, wherein a layer with a frequency-converting material is arranged between the reference structure in the recording medium.

46. The measuring system as claimed in claim 26, wherein the recording medium is patterned such that the reference pattern is integrated into the recording medium.

47. The measuring system as claimed in claim 26, wherein the reference structure is fitted directly to the recording medium.

48. The measuring system as claimed in claim 26, wherein the recording medium comprises at least one layer made of radiation-sensitive resist.

49. The measuring system as claimed in claim 26, wherein the recording medium contains at least one material which experiences a permanent or a reversible change in its ordered state upon irradiation with measuring radiation.

50. The measuring system as claimed in claim 26, the evaluation device comprising:
at least one detection device for detecting spatial variations of at least one property of the recording medium and for generating digitally processable evaluation data; and
at least one computer for determining at least one imaging parameter representing the imaging quality of the imaging system from the evaluation data.

51. The measuring system as claimed in claim 50, wherein the detection device operates optoelectronically.

52. The measuring system according to claim 51, wherein the detection device comprises at least one of at least one digital camera and at least one scanner.

53. The measuring system as claimed in claim 50, wherein the detection device for detecting spatial variations of an ordered state of the recording medium has at least one device that is selective with respect to the degree of order.

54. The measuring system according to claim 53, wherein the device selective with respect to the degree of order is a magnetic-field-sensitive device or a polarization-selective device.

55. The measuring system as claimed in claim 26, further comprising:
a reference structure which is adapted to the mask structure such that a Moiré pattern is generated as a superimposition pattern when the mask structure is imaged onto the reference structure.

56. The measuring system as claimed in claim 26, further comprising:
a reference structure which is effective as a diffraction grating for the radiation used during the measurement.

57. The measuring system as claimed in claim 26, further comprising:
a reference structure which has at least one quasi-punctiform passage (pinhole) for the radiation used during the measurement.

58. The measuring method as claimed in claim 8, wherein a displacement distance of the joint displacement is an integral multiple of a periodicity length of the reference structure plus a fraction of the periodicity length.

59. The measuring method as claimed in claim 9, wherein a displacement distance of the displacement is an integral multiple of a periodicity length of the reference structure plus a fraction of the periodicity length.

60. The measuring method as claimed in claim 16, wherein the at least one device that is selective with respect to the degree of order comprises a magnetic-field-sensitive or polarization-selective device.
